(19) United States
(12) Patent Application Publication
(10) Pub. No.: US 2009/0234088 A1
(43) Pub. Date: Sep. 17, 2009

(54) Hyperbranched Polymer and Method for Producing the Same

(75) Inventors: Hiroki Takemoto, Kitakyushu-shi (JP); Masaaki Ozawa, Funabashi-shi (JP); Akihiro Tanaka, Funabashi-shi (JP); Kei Yasui, Funabashi-shi (JP); Koji Ishizu, Tokyo (JP)

Correspondence Address: OLIFF & BERRIDGE, PLC, P.O. BOX 320850, ALEXANDRIA, VA, 22320-4850, US

(73) Assignees: NISSAN CHEMICAL INDUSTRIES, LTD., Tokyo (JP); TOKYO INSTITUTE OF TECHNOLOGY, Tokyo (JP)

(21) Appl. No.: 12/227,407

(22) PCT Filed: May 18, 2007
(86) PCT No.: PCT/JP2007/060260

§ 371 Date: Nov. 17, 2008

(30) Foreign Application Priority Data
May 19, 2006 (JP) 2006-140507

(51) Int. Cl. C08F 222/08

(52) U.S. Cl. 526/271

(57) ABSTRACT

Disclosed are a novel hyperbranched polymer which is optically and thermally stable and another novel hyperbranched polymer which is water-soluble, and optically and thermally stable. Also disclosed are methods for producing them. Specifically disclosed is a hyperbranched polymer obtained by reducing a molecular terminal (dithiocarbamate group) of a hyperbranched polymer, which is obtained through living-radical polymerization of a dithiocarbamate compound having a vinyl group structure and a maleic anhydride, to a hydrogen atom. Also disclosed is a hyperbranched polymer obtained by hydrolyzing the maleic anhydride unit of the above-obtained polymer, or a hyperbranched polymer obtained by hydrolyzing the maleic anhydride unit of the hyperbranched polymer obtained through living-radical polymerization of a dithiocarbamate compound having a vinyl group structure and a maleic anhydride.

### TECHNICAL FIELD

The present invention relates to a novel hyperbranched polymer and method for producing the same. In other words, the present invention relates to a hyperbranched polymer having such characteristics as being optically and thermally stable and further a hyperbranched polymer having such characteristics as being water-soluble. These hyperbranched polymers are preferably utilized as paints, inks, adhesives, resin fillers, various molding materials, nanometer pore forming agents, chemical and mechanical abrasives, supporting materials for functional substances, nanocapsules, photonic crystals, resist materials, optical materials, electronic materials, information recording materials, printing materials, battery materials, medical materials and magnetic materials.

### BACKGROUND ART

Hyperbranched polymers are classified as dendritic polymers together with dendrimers. While the prior polymers generally have a string form, these dendritic polymers have a highly branched structure. Accordingly, expectations lie in practical application utilizing various characteristics in a respect of having a specific structure, a respect of having a nanometer size, a respect of being capable of forming surfaces retaining many functional groups, a respect of being rendered having a low viscosity compared to linear polymers, a respect of exhibiting a behavior like fine particles with little entanglement of molecules, and a respect of being capable of becoming amorphous with their solubility in a solvent controllable.

Particularly, it is the most remarkable characteristic of dentritic polymers to have a large number of terminal groups. The more the molecular weight is, the more the number of branched chains increases, so that the absolute number of terminal groups becomes larger as the molecular weight of dendritic polymers increases. In such a dendritic polymer having a large number of terminal groups, intermolecular interactions depend largely on the types of the terminal groups, resulting in variations in its glass transition temperature, solubility, thin film forming properties, or the like. Accordingly, such a dendritic polymer has characteristics which no general linear polymer has. Further, to such a dendritic polymer, reactive functional group can be added as terminal groups with an extremely high density, so that its applications as, for example, a high sensitive scavenger for functional substances, a high sensitive multifunctional crosslinking agent, a dispersant for metals or metal oxides, or a coating agent are expected. Accordingly, in dendritic polymers, it becomes an important factor for the exhibition of characteristics of the polymer how the type of the terminal group is selected.

An advantage of the hyperbranched polymer over the dendrimer is in its simplicity for synthesis, which is advantageous particularly in industrial production. Generally, while the dendrimer is synthesized by repeating protection and deprotection, the hyperbranched polymer is synthesized by a one-step polymerization of a so-called ABₓ type monomer having in one molecule thereof, three or more substituents of two types.

A method for synthesizing a hyperbranched polymer by a living radical polymerization of a compound having a vinyl group while having a photo-polymerization initiating ability, is known. As such a synthesis method, for example, a synthesis method of a hyperbranched polymer by a photo-polymerization of a styrene compound having a dithiocarbamate group (see Non-Patent Documents 1, 2 and 3), a synthesis method of a hyperbranched polymer having a dithiocarbamate group by a photo-polymerization of an acryl compound having a dithiocarbamate group (see Non-Patent Documents 4, 5 and 6) and a synthesis method of a hyperbranched polymer having a dithiocarbamate group at a terminal of a molecule in which acid anhydrides are introduced in the main chain thereof by a photo-polymerization of a styrene compound having a dithiocarbamate group and maleic anhydride which are coexisting (see Non-Patent Document 7) are known.

### [Non-Patent Document 1]

Koji Ishizu, Akihide Mori, Macromol. Rapid Commun. 21, 665-668 (2000)

### [Non-Patent Document 2]

Koji Ishizu, Akihide Mori, Polymer International 50, 906-910 (2001)

### [Non-Patent Document 3]

Koji Ishizu, Yoshihiro Ohta, Susumu Kawauchi, Macromolecules Vol. 35, No. 9, 3781-3784 (2002)

### [Non-Patent Document 4]

Koji Ishizu, Takeshi Shibuya, Akihide Mori, Polymer International 51, 424-428 (2002)

### [Non-Patent Document 5]

Koji Ishizu, Takeshi Shibuya, Susumu Kawauchi, Macromolecules Vol. 36, No. 10, 3505-3510 (2002)

### [Non-Patent Document 6]

Koji Ishizu, Takeshi Shibuya, Jaebum Park, Satoshi Uchida, Polymer International 53, 259-265 (2004)

### [Non-Patent Document 7]

Koji Ishizu, Akihide Mori, Takeshi Shibuya, Polymer Vol. 42, 7911-7914 (2001)

### DISCLOSURE OF THE INVENTION

### [Problems to be Solved by the Invention]

However, these hyperbranched polymers have high lipid-solubility, and thus are difficult to be applied to a field in which water-solubility is required. In addition, since these hyperbranched polymers have in the molecule thereof, a dithiocarbamate group having a photo-polymerization initiating ability, they remain in a living state relative to a light and do not have high thermal stability. Thus, a water-soluble as well as optically and thermally stable hyperbranched polymer having no dithiocarbamate group has been desired.

It is an object of the present invention to provide an optically and thermally stable novel hyperbranched polymer and further a water-soluble as well as optically and thermally stable novel hyperbranched polymer, and to provide a production method of these hyperbranched polymers.

### [Means for Solving the Problem]

As the result of making extensive and intensive studies toward solving the above-described problems, the present invention relates to inventions according to the following aspects.

According to a first aspect, a hyperbranched polymer having a structure represented by Formula (1):

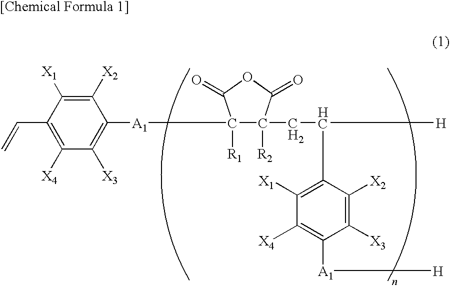

(where each of R₁ and R₂ independently represents a hydrogen atom, an alkyl group having 1 to 10 carbon atoms or a phenyl group, or R₁ and R₂ are bonded to each other to form a cycloalkyl group or cycloalkenyl group having 4 to 10 carbon atoms together with a carbon atom bonded to R₁ and R₂; A₁ represents a linear, branched or cyclic alkylene group having 1 to 20 carbon atoms, which may contain an ether bond or an ester bond; X₁, X₂, X₃ and X₄ individually represent a hydrogen atom, an alkyl group having 1 to 20 carbon atoms or an alkoxy group having 1 to 20 carbon atoms; and n is the number of repeating unit structures which represents an integer of 2 to 100,000).

According to a second aspect, in the hyperbranched polymer according to the first aspect, weight average molecular weight is 500 to 5,000,000, as measured by a gel permeation chromatography in a converted molecular weight as polystyrene.

According to a third aspect, a production method of the hyperbranched polymer according to the first aspect including:

living-radical polymerizing a dithiocarbamate compound represented by Formula (2):

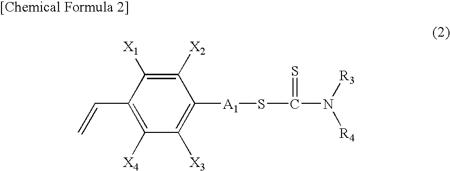

(where A₁, X₁, X₂, X₃ and X₄ represent the same as defined in Formula (1); R₃ and R₄ individually represent an alkyl group having 1 to 5 carbon atoms, a hydroxyalkyl group having 1 to 5 carbon atoms or an arylalkyl group having 7 to 12 carbon atoms, or R₃ and R₄ may be bonded to each other to form a ring together with a nitrogen atom bonded to R₃ and R₄),

and maleic anhydride compound represented by Formula (3):

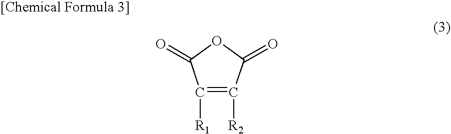

(where R₁ and R₂ represent the same as defined in Formula (1)), which are coexisting; and reducing a dithiocarbamate group at a molecular terminal of the hyperbranched polymer obtained by the polymerization to a hydrogen atom.

According to a fourth aspect, in the production method according to the third aspect, the dithiocarbamate compound is N,N-diethyldithiocarbamylmethylstyrene.

According to a fifth aspect, in the production method according to the third aspect, the maleic anhydride compound is maleic anhydride.

According to a sixth aspect, in the production method according to the third aspect, the dithiocarbamate compound is N,N-diethyldithiocarbamylmethylstyrene and the maleic anhydride compound is maleic anhydride.

According to a seventh aspect, in the production method according to the third aspect, the reduction is performed by irradiating a light in the presence of tributyltin hydride.

According to an eighth aspect, in the production method according to the third aspect, the reduction is performed by irradiating a light in the presence of tributyltin hydride in an organic solvent solution containing the hyperbranched polymer having a dithiocarbamate group at a molecular terminal thereof.

According to a ninth aspect, a hyperbranched polymer having a structure represented by Formula (4):

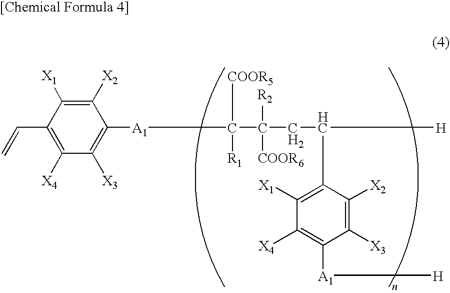

(where R₁, R₂, A₁, X₁, X₂, X₃ and X₄ represent the same as defined in Formula (1); R₅ and R₆ individually represent a hydrogen atom or a metal atom; and n is the number of repeating unit structures which represents an integer of 2 to 100,000).

According to a tenth aspect, a production method of the hyperbranched polymer according to the ninth aspect, including further hydrolyzing the hyperbranched polymer according to the first aspect.

According to an eleventh aspect, in the production method according to the tenth aspect, the hydrolysis is performed according to an alkali hydrolysis reaction using a water-soluble base which is an alkali metal hydroxide or an alkaline earth metal hydroxide, or according to an acid hydrolysis reaction using a water-soluble acid which is a halogenated hydrogen acid, nitric acid or sulfuric acid.

According to a twelfth aspect, in the production method according to the tenth aspect, the hydrolysis is performed in a solvent mixture of water and an organic solvent, according to an alkali hydrolysis reaction using a water-soluble base which is an alkali metal hydroxide or an alkaline earth metal hydroxide, or according to an acid hydrolysis reaction using a water-soluble acid which is a halogenated hydrogen acid, nitric acid or sulfuric acid.

According to a thirteenth aspect, a hyperbranched polymer having a structure represented by Formula (5):

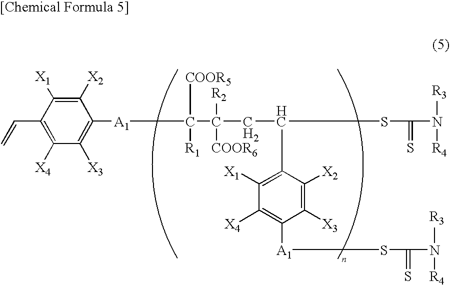

(where R₁, R₂, R₃, R₄, R₅, R₆, A₁, X₁, X₂, X₃ and X₄ represent the same as defined in Formula (1), Formula (2), Formula (3) and Formula (4); and n is the number of repeating unit structures which represents an integer of 2 to 100,000).

According to a fourteenth aspect, a production method of the hyperbranched polymer according to the thirteenth aspect, including hydrolyzing the hyperbranched polymer having a dithiocarbamate group at a molecular terminal thereof obtained by living-radical polymerizing the dithiocarbamate compound represented by Formula (2) according to the third aspect and the maleic anhydride compound represented by Formula (3) according to the third aspect which are coexisting.

According to a fifteenth aspect, in the production method according to the fourteenth aspect, the dithiocarbamate compound is N,N-diethyldithiocarbamylmethylstyrene and the maleic anhydride compound is maleic anhydride.

According to a sixteenth aspect, in the production method according to the fourteenth aspect, the hydrolysis is performed according to an alkali hydrolysis reaction using a water-soluble base which is an alkali metal hydroxide or an alkaline earth metal hydroxide, or according to an acid hydrolysis reaction using a water-soluble acid which is a halogenated hydrogen acid, nitric acid or sulfuric acid.

According to a seventeenth aspect, in the production method according to the fourteenth aspect, the hydrolysis is performed in a solvent mixture of water and an organic solvent, according to an alkali hydrolysis reaction using a water-soluble base which is an alkali metal hydroxide or an alkaline earth metal hydroxide, or according to an acid hydrolysis reaction using a water-soluble acid which is a halogenated hydrogen acid, nitric acid or sulfuric acid.

According to an eighteenth aspect, a production method of the hyperbranched polymer according to the ninth aspect, including reducing the hyperbranched polymer according to the thirteenth aspect by reducing the dithiocarbamate group at a molecular terminal of the hyperbranched polymer to a hydrogen atom by the reduction method according to the seventh aspect or the eighth aspect.

### [Effects of the Invention]

According to the present invention, an alternating copolymer which is an optically and thermally stable hyperbranched polymer having a hydrogen atom at a molecular terminal thereof can be obtained. Further, a hyperbranched polymer to which a characteristic of water-soluble is imparted by introducing a carboxyl group in the polymer can also be obtained.

In addition, according to the production method of the present invention, a hyperbranched polymer having these characteristics can be simply and efficiently obtained.

### BEST MODES FOR CARRYING OUT THE INVENTION

The hyperbranched polymer of the present invention is a hyperbranched polymer having a structure represented by Formula (1), Formula (4) or Formula (5).

In these Formulae (1), (4) and (5), each of R₁ and R₂ independently represents a hydrogen atom, an alkyl group having 1 to 10 carbon atoms or a phenyl group, or R₁ and R₂ are bonded to each other to form a cycloalkyl group or cycloalkenyl group having 4 to 10 carbon atoms together with a carbon atom bonded to R₁ and R₂.

A₁ represents a linear, branched or cyclic alkylene group having 1 to 20 carbon atoms, which may contain an ether bond or an ester bond; X₁, X₂, X₃ and X₄ individually represent a hydrogen atom, an alkyl group having 1 to 20 carbon atoms or an alkoxy group having 1 to 20 carbon atoms; and n is the number of repeating unit structures which represents an integer of 2 to 100,000.

In addition, R₃ and R₄ individually represent an alkyl group having 1 to 5 carbon atoms, a hydroxyalkyl group having 1 to 5 carbon atoms or an arylalkyl group having 7 to 12 carbon atoms, or R₃ and R₄ can be bonded to each other to form a ring together with a nitrogen atom bonded to R₃ and R₄. R₅ and R₆ individually represent a hydrogen atom or a metal atom.

In these formulae, specific examples of R₁ and R₂ include a hydrogen atom, a methyl group, an ethyl group, an isopropyl group, an n-butyl group, a t-butyl group and a phenyl group, and a hydrogen atom is preferred.

In addition, specific examples of the alkylene group of A₁ include a linear alkylene group such as a methylene group, an ethylene group, an n-propylene group, an n-butylene group and an n-hexylene group; and a branched alkylene group such as an isopropylene group, an isobutylene group and a 2-methylpropylene group. In addition, examples of the cyclic alkylene group include an alicyclic aliphatic group having 3 to 30 carbon atoms and having a monocyclic, polycyclic or crosslinked cyclic structure. Specific examples thereof include groups having 4 or more carbon atoms and having a monocyclo, bicyclo, tricyclo, tetracyclo or pentacyclo structure.

For example, structural examples (a) to (s) of the alicyclic part in the alicyclic aliphatic group are shown as follows.

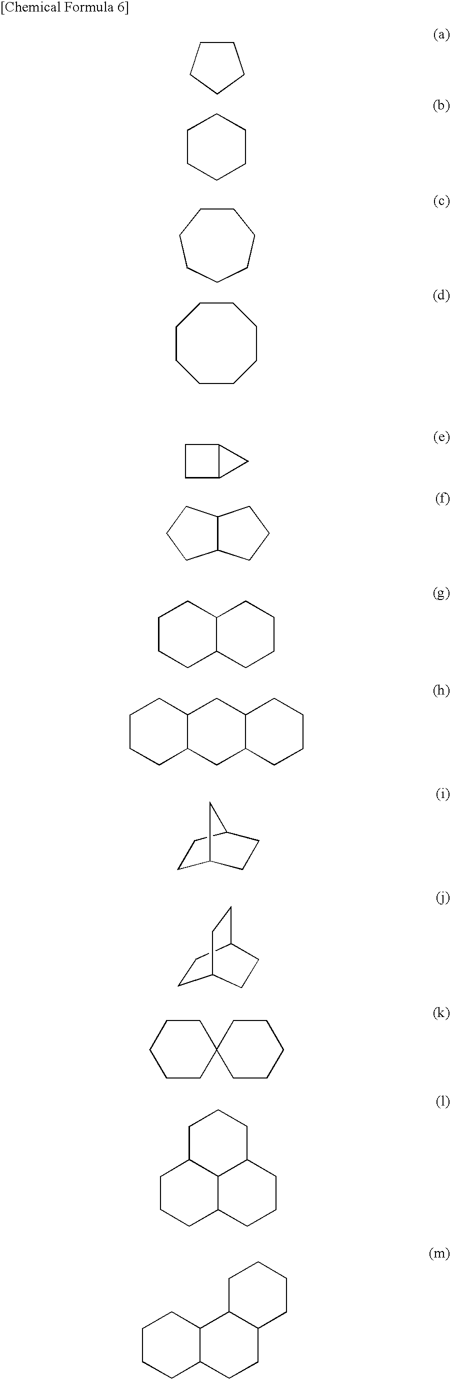

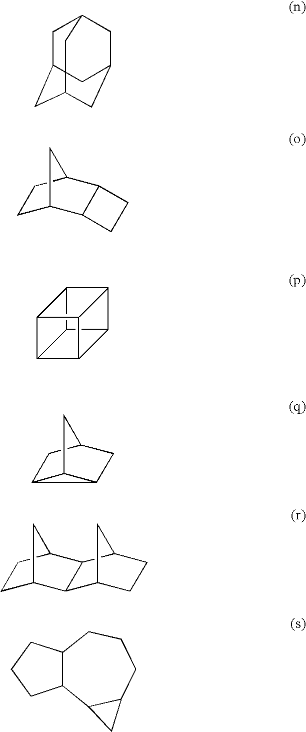

In addition, examples of the alkyl group having 1 to 20 carbon atoms of X₁, X₂, X₃ and X₄ include a methyl group, an ethyl group, an isopropyl group, a cyclohexyl group and an n-pentyl group. Examples of the alkoxy group having 1 to 20 carbon atoms include a methoxy group, an ethoxy group, an isopropoxy group, a cyclohexyloxy group and an n-pentyloxy group.

Particularly, preferred examples of X₁, X₂, X₃ and X₄ include a hydrogen atom or an alkyl group having 1 to 20 carbon atoms.

Examples of the alkyl group having 1 to 5 carbon atoms of R₃ and R₄ include a methyl group, an ethyl group, an isopropyl group, a t-butyl group, a cyclopentyl group and an n-pentyl group.

In addition, examples of the hydroxyalkyl group having 1 to 5 carbon atoms include a hydroxymethyl group, a hydroxyethyl group and a hydroxypropyl group.

Examples of the arylalkyl group having 7 to 12 carbon atoms include a benzyl group and a phenethyl group.

Examples of the ring formed with R₃ and R₄ together with a nitrogen atom bonded to R₃ and R₄ include a 4- to 8-membered ring; a ring containing 4 to 6 methylene groups in the ring; and a ring containing an oxygen atom or a sulfur atom and 4 to 6 methylene groups in the ring. Specific examples of the ring formed with R₃ and R₄ together with a nitrogen atom bonded to R₃ and R₄ include a piperizine ring, a pyrrolidine ring, a morpholine ring, a thiomorpholine ring and a homopiperizine ring.

R₅ and R₆ individually represent a hydrogen atom or a metal atom and specific examples of the metal atom include alkali metals such as lithium, sodium and potassium and alkaline earth metals such as beryllium, magnesium and calcium.

The hyperbranched polymer having a structure represented by Formula (1) of the present invention takes a structure in which to a structure at an initiation site having a vinyl group and represented by Formula (6):

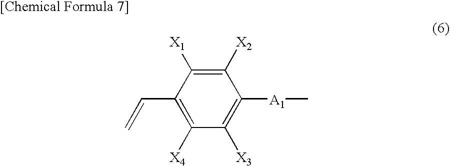

a repeating unit structure represented by Formula (7):

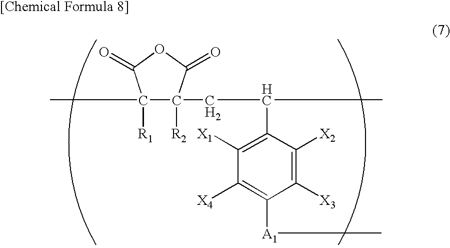

is linked.

In addition, the hyperbranched polymer having a structure represented by Formula (4) of the present invention takes a structure in which to a structure at an initiation site having a vinyl group and represented by Formula (6), a repeating unit structure represented by Formula (8):

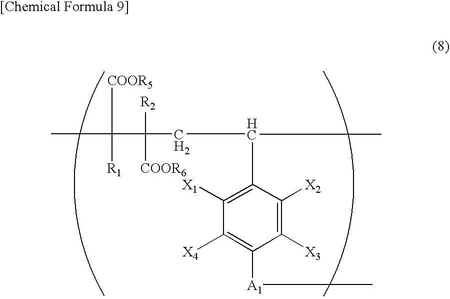

is linked.

The hyperbranched polymer having a structure represented by Formula (5) of the present invention also takes a structure in which to a structure at an initiation site having a vinyl group and represented by Formula (6), a repeating unit structure represented by Formula (8) is linked.

Then, the difference between the hyperbranched polymer having a structure represented by Formula (4) and the hyperbranched polymer having a structure represented by Formula (5) resides in that while the hyperbranched polymer having a structure represented by Formula (4) has at a molecular terminal thereof, a hydrogen atom, the hyperbranched polymer having a structure represented by Formula (5) has at a molecular terminal thereof, a dithiocarbamate group.

The linked state of structural formulae of the hyperbranched polymers represented by Formulae (1), (4) and (5) of the present invention is described with General Formula (9):

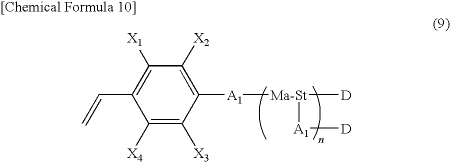

(where Ma represents Formula (10):

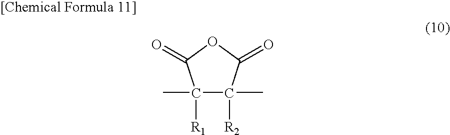

(where R₁ and R₂ represent the same as defined in Formulae (1) and (3)), or Formula (11):

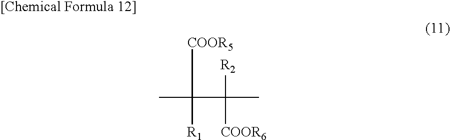

(where R₁, R₂, R₅ and R₆ represent the same as defined in Formula (4)),

St represents Formula (12):

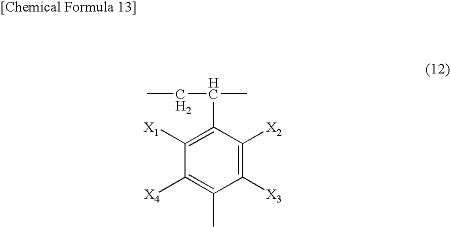

(where X₁, X₂, X₃ and X₄ represent the same as defined in Formula (1)),

and D represents a hydrogen atom or a dithiocarbamate group).

The hyperbranched polymer represented by Formula (1) of the present invention is represented by General Formula (9) where Ma represents Formula (10) and D represents a hydrogen atom; the hyperbranched polymer represented by Formula (4) is represented by General Formula (9) where Ma represents Formula ( 11) and D represents a hydrogen atom; and the hyperbranched polymer represented by Formula (5) is represented by General Formula (9) where Ma represents Formula (11) and the molecular terminal D represents a dithiocarbamate group.

By these constitutions, the hyperbranched polymer of the present invention can be represented as that taking a structure in which to a structure at an initiation site having a vinyl group and represented by Formula (6), a repeating unit structure represented by Formula (13):

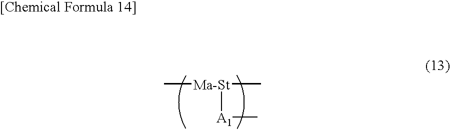

is linked.

Then, when the number n of repeating unit structures is 2, as the structure, Formulae (14) and (15):

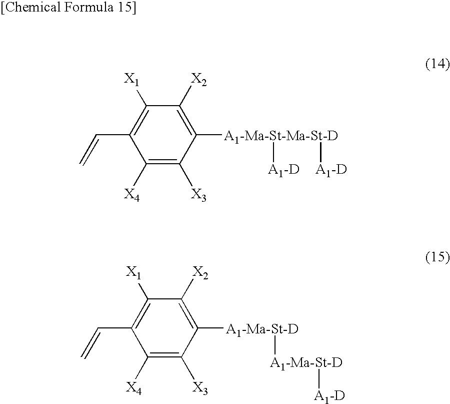

can be considered. The hyperbranched polymer of the present invention contains both the structures.

When the number n of repeating unit structures is 3, as the structure, Formulae (16) to (20):

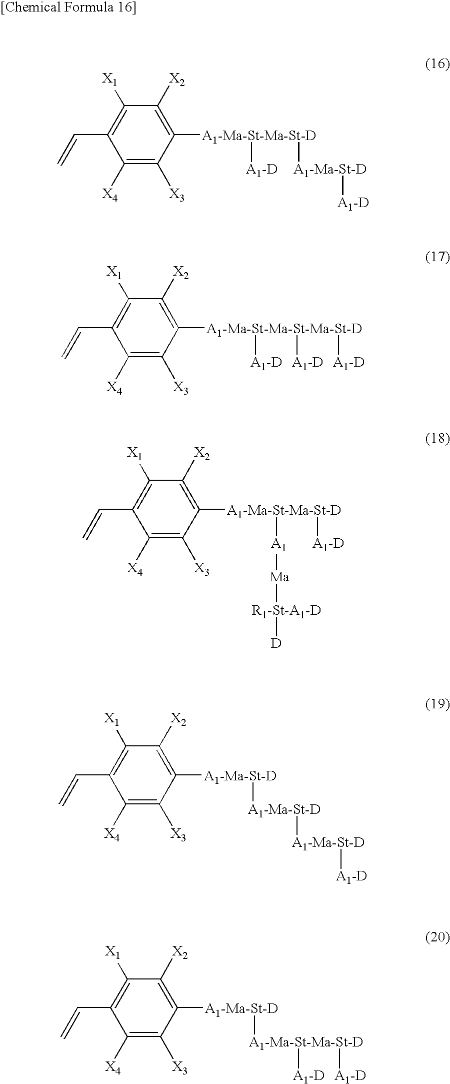

can be considered. The hyperbranched polymer of the present invention contains any of these structures.

When the number n of repeating unit structures is 4 or more, further many structures can be considered and the hyperbranched polymer of the present invention contains any of the structures.

The linked state of structural formulae of the hyperbranched polymers represented by Formulae (1), (4) and (5) of the present invention is as described using General Formula (9). In other words, the hyperbranched polymer represented by Formula (1) of the present invention encompasses all of those having structures in which to a structure at an initiation site represented by Formula (6), two or more repeating unit structures represented by Formula (7) are linked and the hyperbranched polymer represented by Formulae (4) and (5) encompasses all of those having structures in which to a structure at an initiation site represented by Formula (6), two or more repeating unit structures represented by Formula (8) are linked. Then, there are cases where the hyperbranched polymer becomes a structure in which repeating unit structures are regularly bonded at three points and branched structures are formed, and where the hyperbranched polymer becomes a structure in which repeating unit structures are bonded at two points and no branched structure is formed, but linear structures are formed. However, the present invention encompasses any of these hyperbranched polymers.

Here, the hyperbranched polymer of the present invention have mainly repeating unit structures represented by Formula (7) or (8). However, the hyperbranched polymer may partially contain a structure in which the sequence mode of the repeating unit structures of a dithiocarbamate compound and maleic anhydride compound or of a dithiocarbamate compound and a hydrolysis product of maleic anhydride compound is a random mode or a block mode individually. In addition, in the hyperbranched polymers represented by Formulae (4) and (5), maleic anhydride compound may be partially remained as a residue.

Further, in the hyperbranched polymer of the present invention represented by Formula (1) or (4) and having a hydrogen atom at the molecular terminal thereof, a portion of the molecular terminal thereof may be remained as a dithiocarbamate group.

In addition, when the hyperbranched polymer represented by Formula (4) is produced from the hyperbranched polymer represented by Formula (5) according to the below-described production method, a portion of the molecular terminal thereof may be remained as a dithiocarbamate group.

Alternatively, when the compound represented by Formula (2) exists excessive over maleic anhydride compound represented by Formula (3), a structure in which to the terminal of the repeating unit structures represented by Formula (7) or (8), further an excessive structure represented by Formula (21):

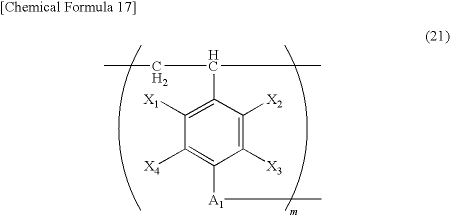

(where m is the number of repeating unit structures which shows an integer of 1 to 100),

is bonded, can be considered, and the hyperbranched polymer of the present invention may contain such a structure.

Here, any hyperbranched polymer of the present invention has a weight average molecular weight Mw, measured by a gel permeation chromatography in a converted molecular weight as polystyrene, of 500 to 5,000,000, preferably 1,000 to 1,000,000, more preferably 2,000 to 500,000. The degree of dispersion which is a ratio of Mw (weight average molecular weight)/Mn (number average molecular weight) of the hyperbranched polymer is 1.0 to 10.0, preferably 1.1 to 9.0, more preferably 1.2 to 8.0.

Furthermore, specific representative examples of the hyperbranched polymer represented by Formula (1) include a hyperbranched polymer represented by Formula (22):

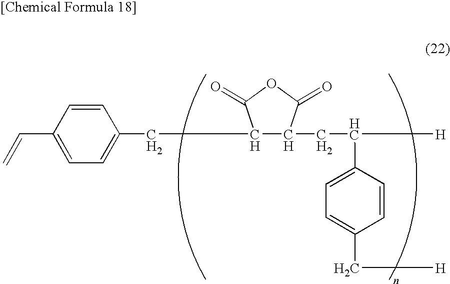

(where n is the number of repeating unit structures which represents an integer of 2 to 100,000).

Specific representative examples of the hyperbranched polymer represented by Formula (4) include a hyperbranched polymer represented by Formula (23):

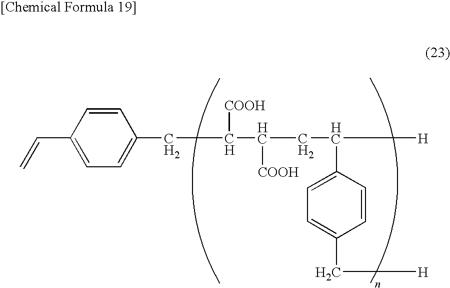

(where n is the number of repeating unit structures which represents an integer of 2 to 100,000),

and a hyperbranched polymer represented by Formula (24):

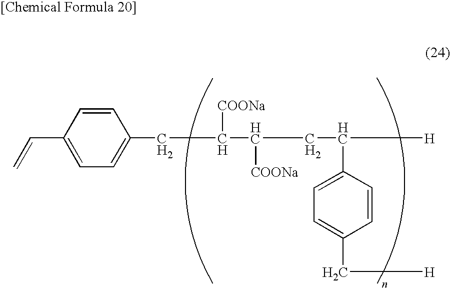

(where n is the number of repeating unit structures and represents an integer of 2 to 100,000).

Specific representative examples of the hyperbranched polymer represented by Formula (5) include a hyperbranched polymer represented by Formula (25):

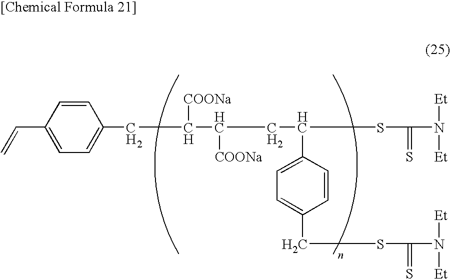

(where n is the number of repeating unit structures and represents an integer of 2 to 100,000),

and a hyperbranched polymer represented by Formula (26):

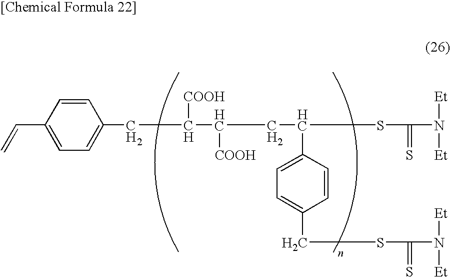

(where n is the number of repeating unit structures and represents an integer of 2 to 100,000).

Next, the production method of the hyperbranched polymer of the present invention is described.

First, the production method of the hyperbranched polymer of the present invention represented by Formula (1):

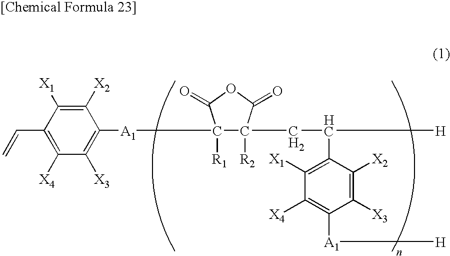

(where each of R₁ and R₂ independently represents a hydrogen atom, an alkyl group having 1 to 10 carbon atoms or a phenyl group, or R₁ and R₂ are bonded to each other to form a cycloalkyl group or cycloalkenyl group having 4 to 10 carbon atoms together with a carbon atom bonded to R₁ and R₂; A₁ represents a linear, branched or cyclic alkylene group having 1 to 20 carbon atoms, which may contain an ether bond or an ester bond; X₁, X₂, X₃ and X₄ individually represent a hydrogen atom, an alkyl group having 1 to 20 carbon atoms or an alkoxy group having 1 to 20 carbon atoms; and n is the number of repeating unit structures which represents an integer of 2 to 100,000),

is described.

The hyperbranched polymer represented by Formula (1) can be produced by reducing to a hydrogen atom, a dithiocarbamate group at a molecular terminal of a hyperbranched polymer obtained by living-radical polymerizing a dithiocarbamate compound represented by Formula (2) and maleic anhydride compound represented by Formula (3) which are coexisting.

First, the production method of the hyperbranched polymer having a dithiocarbamate group at a molecular terminal thereof is described.

The dithiocarbamate compound represented by Formula (2) is the above-described compound represented by Formula (2):

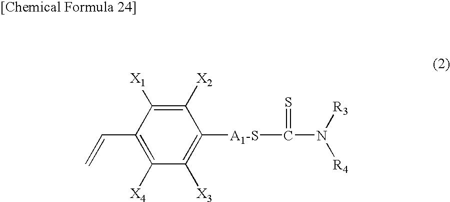

where A₁ X₁, X₂, X₃ and X₄ represent the same as defined above; and

R₃ and R₄ individually represent an alkyl group having 1 to 5 carbon atoms, a hydroxyalkyl group having 1 to 5 carbon atoms or an arylalkyl group having 7 to 12 carbon atoms, or

R₃ and R₄ can be bonded to each other to form a ring together with a nitrogen atom bonded to R₃ and R₄.

Examples of the alkyl group having 1 to 5 carbon atoms include a methyl group, an ethyl group, an isopropyl group, a t-butyl group, a cyclopentyl group and an n-pentyl group.

Examples of the hydroxyalkyl group having 1 to 5 carbon atoms include a hydroxymethyl group, a hydroxyethyl group and a hydroxypropyl group. Examples of the arylalkyl group having 7 to 12 carbon atoms include a benzyl group and a phenethyl group.

Examples of the ring formed with R₃ and R₄ together with a nitrogen atom bonded to R₃ and R₄ include a 4- to 8-membered ring; a ring containing 4 to 6 methylene groups in the ring; and a ring containing an oxygen atom or a sulfur atom and 4 to 6 methylene groups.

Specific examples of the ring formed with R₃ and R₄ together with a nitrogen atom bonded to R₃ and R₄ include a piperizine ring, a pyrrolidine ring, a morpholine ring, a thiomorpholine ring and a homopiperizine ring.

The compound represented by Formula (2) can be easily obtained according to a nucleophilic substitution reaction between a compound represented by Formula (27):

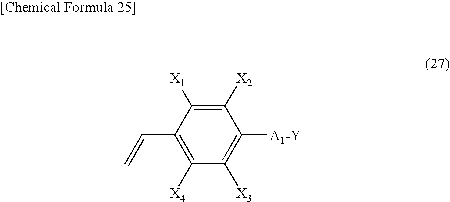

and a compound represented by Formula (28):

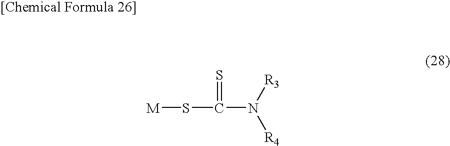

In Formula (27), Y represents a leaving group. Examples of the leaving group include a fluoro group, a chloro group, a bromo group, an iodo group, a mesyl group and a tosyl group.

In Formula (28), M represents lithium, sodium or potassium.

It is preferred that the nucleophilic substitution reaction is usually performed in an organic solvent capable of dissolving both the above two types of compounds. After the completion of the reaction, by a liquid separation treatment using water/nonaqueous organic solvent or by a recrystallization treatment, the compound represented by Formula (2) can be obtained in a high purity. In addition, the compound represented by Formula (2) can be produced referring to the methods described in Macromol. Rapid Commun. 21, 665-668 (2000) and Polymer International 51, 424-428 (2002).

Specific examples of the compound represented by Formula (2) include N,N-diethyldithiocarbamylmethylstyrene.

The maleic anhydride compound represented by Formula (3) are also above-described those represented by the following Formula (3):

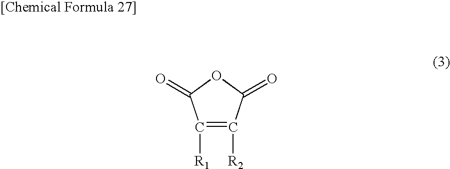

where each of R₁ and R₂ independently represents a hydrogen atom, an alkyl group having 1 to 10 carbon atoms or a phenyl group, or R₁ and R₂ are bonded to each other to form a cycloalkyl group or cycloalkenyl group having 4 to 10 carbon atoms together with a carbon atom bonded to R₁ and R₂.

Specific examples of the maleic anhydride compound represented by Formula (3) include maleic anhydride, citraconic anhydride, 2,3-dimethyl maleic anhydride, 2-ethyl maleic anhydride, 2,3-diethyl maleic anhydride, 2-isopropyl maleic anhydride, 2,3-diisopropyl maleic anhydride, 2-n-butyl maleic anhydride, 2,3-di(n-butyl) maleic anhydride, 2-t-butyl maleic anhydride, 2,3-di(t-butyl) maleic anhydride, 2-phenyl maleic anhydride, 2,3-diphenyl maleic anhydride, 1 -cyclopentene- 1,2-dicarboxylic acid anhydride and 3,4,5,6-tetrahydro phthalic anhydride.

Then, by living-radical polymerizing the dithiocarbamate compound represented by Formula (2) and the maleic anhydride compound represented by Formula (3) which are coexisting, a hyperbranched polymer having a dithiocarbamate group at a molecular terminal thereof in which acid anhydrides are introduced can be obtained.

The living-radical polymerization can be performed by a heretofore known polymerization type such as a bulk polymerization, a solution polymerization, a suspension polymerization and an emulsion polymerization. Particularly, the solution polymerization is preferred.

In the case of the solution polymerization, the compound represented by Formula (2) and the maleic anhydride compound represented by Formula (3) in any ratios thereof can be polymerized in a solvent capable of dissolving these compounds. For example, relative to the amount of the compound represented by Formula (2), the amount of the maleic anhydride compound represented by Formula (3) may be 0.1 to 2.0 times molar equivalent, preferably 0.2 to 1.5 times molar equivalent, more preferably 0.5 to 1.3 times molar equivalent, most preferably 0.8 to 1.1 times molar equivalent. Additionally, though the concentrations of the compound represented by Formula (2) and the maleic anhydride compound represented by Formula (3) in the solution are arbitrary, for example, the total amount of the compound represented by Formula (2) and the maleic anhydride compound represented by Formula (3) is 1 to 80% by mass, preferably 2 to 70% by mass, more preferably 5 to 60% by mass, most preferably 8 to 50% by mass, based on the total mass of the compound represented by Formula (2), the maleic anhydride compound represented by Formula (3) and the solvent. The solvent is not particularly limited so long as it is a solvent capable of dissolving the compound represented by Formula (2) and the maleic anhydride compound represented by Formula (3). Specific examples of the solvent include: ester compounds such as ethyl acetate and methyl acetate; aromatic hydrocarbons such as benzene, toluene, xylene and ethyl benzene; ether compounds such as tetrahydrofuran and diethyl ether; ketone compounds such as acetone, methyl ethyl ketone, methyl isobutyl ketone and cyclohexanone; and aliphatic hydrocarbons such as n-heptane, n-hexane and cyclohexane. These solvents may be used individually or in combination of two or more types thereof.

Though the living-radical polymerization of the compound represented by Formula (2) and the maleic anhydride compound represented by Formula (3) which are coexisting can be performed in a solvent by heating or irradiating a light such as an ultraviolet ray, the polymerization is preferably performed by irradiating a light such as an ultraviolet ray. In the living-radical polymerization, it is necessary that before the initiation of the polymerization, oxygen in the reaction system is fully purged and the inside of the reaction system is preferably replaced with an inert gas such as nitrogen and argon. The polymerization time is, for example, 0.1 to 100 hours, preferably 1 to 50 hours, more preferably 3 to 30 hours. Usually, according to the time course of the polymerization, the conversion ratio of the monomer (the compound represented by Formula (2) and the maleic anhydride compound represented by Formula (3)) is elevated. The polymerization temperature is not particularly limited. However, it is, for example, 0 to 200° C., preferably 10 to 150° C., more preferably 20 to 100° C.

The living-radical polymerization of the compound represented by Formula (2) and the maleic anhydride compound represented by Formula (3) which are coexisting can be also performed referring to a method described in Polymer Vol. 42, 7911-7914 (2001).

According to the method, by living-radical polymerizing the dithiocarbamate compound represented by Formula (2) and the maleic anhydride compound represented by Formula (3) which are coexisting, the hyperbranched polymer having a dithiocarbamate group at a molecular terminal thereof in which acid anhydrides are introduced can be obtained.

In addition, during the living-radical polymerization, the molecular weight, the molecular weight distribution and the degree of branching can be controlled so long as the structure as the hyperbranched polymer is not impaired. For controlling the molecular weight and the molecular weight distribution, a chain transfer agent such as mercaptans and sulfides or a sulfide compound such as tetraethyl thiuram disulfide can be used. Further, if desired, anti-oxidants such as hindered phenols, ultraviolet rays absorbing agents such as benzotriazoles, polymerization inhibitors such as 4-tert-butylcathecol, hydroquinone, nitrophenol, nitrocresol, picric acid, phenothiazine and dithiobenzoyl disulfide can be used.

Next, by reducing to a hydrogen atom, the dithiocarbamate group of the hyperbranched polymer having a dithiocarbamate group at a molecular terminal thereof in which acid anhydrides are introduced and which is obtained as described above, in other words, by converting the dithiocarbamate group into a hydrogen atom, the hyperbranched polymer having the structure represented by Formula (1) of the present invention can be obtained.

The reducing method is not particularly limited so long as the method is a method capable of converling lhe dilhiocarbarnate group into a hydrogen alom.

The reducing reaction can be performed using heretofore known reducing agents such as hydrogen, hydrogen iodide, hydrogen sulfide, lithium aluminum hydride, sodium boron hydride, tributyltin hydride, tris(trimethylsilyl) silane and thioglycolic acid. The used amount of the reducing agent may be 1 to 20 times molar equivalent, preferably 1.2 to 10 times molar equivalent, more preferably 1.5 to 5 times molar equivalent relative to the number of dithiocarbamate groups in the hyperbranched polymer. The conditions for the reducing reaction are appropriately selected from reaction times of 0.01 to 100 hours and reaction temperatures of 0 to 200° C., preferably from reaction times of 0.05 to 50 hours and reaction temperatures of 10 to 100° C.

The reduction is preferably performed in water or an organic solvent. The solvent to be used is preferably a solvent capable of dissolving the hyperbranched polymer having the dithiocarbamate group in which acid anhydrides are introduced and the reducing agent. In addition, when the solvent is the same solvent as that used during the production of the hyperbranched polymer having a dithiocarbamate group, the reaction operation becomes simple, which is preferred.

As the reducing method, preferred is a reducing reaction performed by irradiating a light in an organic solvent solution using as a reducing agent, a compound used for the reduction under a radical reaction condition such as tributyltin hydride. Examples of the organic solvent include aromatic hydrocarbons such as benzene, toluene, xylene and ethylbenzene; ether compounds such as tetrahydrofuran and diethyl ether; ketone compounds such as acetone, methyl ethyl ketone, methyl isobutyl ketone and cyclohexanone; and aliphatic hydrocarbons such as n-heptane, n-hexane and cyclohexane. These solvents may be used individually or in combination of two or more types thereof.

The light irradiation can be performed by irradiating from the inside or outside of the reaction system using an ultraviolet ray irradiating lamp such as a low-pressure mercury lamp, a high-pressure mercury lamp, an ultra high-pressure mercury lamp and a xenone lamp. In the reducing reaction, a reducing agent such as tributyltin hydride is preferably used in an amount of 1.0 to 20 times molar equivalent, preferably 1.2 to 10 times molar equivalent, more preferably 1.5 to 5 times molar equivalent relative to the number of dithiocarbamate groups in the hyperbranched polymer. Also, an organic solvent is used preferably in an amount of 0.2 to 1,000 times mass, preferably 1 to 500 times mass, more preferably 5 to 100 times mass, most preferably 10 to 50 times mass relative to the mass of the hyperbranched polymer having a dithiocarbamate group at a molecular terminal thereof. Further, in the reducing reaction, it is necessary that before the initiation of the reaction, oxygen in the reaction system is fully purged and the inside of the reaction system is preferably replaced with an inert gas such as nitrogen and argon. The reaction conditions are appropriately selected from reaction times of 0.01 to 100 hours and from reaction temperatures of 0 to 200° C., however, preferably the reaction time is 0.05 to 50 hours and the reaction temperature is 10 to 100° C., more preferably the reaction time is 0.1 to 10 hours and the reaction temperature is 20 to 60° C.

The hyperbranched polymer represented by Formula (1) of the present invention obtained by the above-described reduction can be separated from the solvent out of the reaction solution by distilling-off the solvent or by solid-liquid separation. Also, by adding the reaction solution to a poor solvent, the hyperbranched polymer of the present invention can be precipitated to be recovered as a powder.

Next, the production method of the hyperbranched polymer of the present invention having a structure represented by Formula (4):

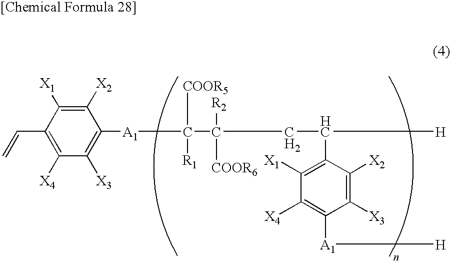

(where R₁, R₂, A₁, X₁, X₂, X₃ and X₄ represent the same as defined in Formula (1); R₅ and R₆ individually represent a hydrogen atom or a metal atom; and n is the number of repeating unit structures which represents an integer of 2 to 100,000), is described.

The hyperbranched polymer represented by Formula (4) can be produced by reducing to a hydrogen atom, a dithiocarbamate group at a molecular terminal of the hyperbranched polymer obtained by living-radical polymerizing the dithiocarbamate compound represented by Formula (2) and the maleic anhydride compound represented by Formula (3) which are coexisting and then by hydrolyzing the resultant hyperbranched polymer.

In other words, the hyperbranched polymer can be produced by hydrolyzing the hyperbranched polymer represented by Formula (1).

The hyperbranched polymer represented by Formula (1) can be obtained by the above-described production method.

Next, by hydrolyzing the hyperbranched polymer (represented by Formula (1)) which has been obtained as described above and in which the dithiocarbamate group at a molecular terminal thereof is reduced to a hydrogen atom and acid anhydrides are introduced, in other words, by converting the acid anhydrides into carboxylic groups, the hyperbranched polymer having a structure represented by Formula (4) of the present invention can be obtained.

The hydrolyzing method is not particularly limited so long as the method is capable of converting acid anhydrides into carboxylic groups.

The hydrolysis can be performed by an alkali hydrolyzing reaction using water-soluble bases which are alkali metal hydroxides such as lithium hydroxide, sodium hydroxide and potassium hydroxide; and alkaline earth metal hydroxides such as beryllium hydroxide, magnesium hydroxide and calcium hydroxide, or by an acid hydrolyzing reaction using water-soluble acids such as hydrofluoric acid, hydrochloric acid, hydrobromic acid, hydroiodic acid, nitric acid and sulfuric acid.

The used amount of the water-soluble bases and water-soluble acids may be 1.0 to 200 times molar equivalent, preferably 1.5 to 100 times molar equivalent, more preferably 2.0 to 50 times molar equivalent relative to the number of acid anhydride groups in the hyperbranched polymer. The conditions for the hydrolyzing reaction are appropriately selected from reaction times of 0.01 to 200 hours and reaction temperatures of 0 to 200° C., preferably from reaction times of 0.1 to 150 hours and reaction temperatures of 10 to 100° C.

The hydrolyzing reaction can be performed in water or in a solvent mixture of water and an organic solvent. The solvent to be used is preferably capable of dissolving the hyperbranched polymer having the dithiocarbamate group in which acid anhydrides are introduced, and the water-soluble bases or water-soluble acids.

As the method of the hydrolyzing reaction, preferred is a reaction using bases or acids used in a hydrolyzing reaction such as water-soluble bases or water-soluble acids in water or in a solvent mixture of water and an organic solvent. Examples of the organic solvent include ether compounds such as tetrahydrofuran and ethyl ether; ketone compounds such as acetone, methyl ethyl ketone, methyl isobutyl ketone and cyclohexanone; amide compounds such as N,N-dimethylformamide, N,N-dimethylacetamide and N-methyl-2-pyrrolidone; and sulfoxide, sulfolan compounds such as dimethyl sulfoxide and sulfolan. These solvents may be used individually or in combination of two or more types thereof. The solvent is preferably an organic solvent capable of being dissolved in water, however is not particularly limited.

In addition, preferred is a case where a solvent mixture of water and an organic solvent is used as the solvent and in this case, water and the organic solvent can be mixed in any ratios thereof. Though the mixing ratio is not particularly limited, it is preferred that the mass of the organic solvent is, for example, 1 to 99% by mass, preferably 30 to 98% by mass, more preferably 50 to 95% by mass, based on the total mass of water and the organic solvent. In this hydrolyzing reaction, heretofore known water-soluble bases or heretofore known water-soluble acids are used in an amount of 1 to 200 times molar equivalent, preferably 1.5 to 100 times molar equivalent, more preferably 2 to 50 times molar equivalent relative to the number of acid anhydrides in the hyperbranched polymer. In addition, water or a solvent mixture of water and an organic solvent is preferably used in an amount of 0.2 to 1,000 times mass, preferably 1 to 500 times mass, more preferably 5 to 100 times mass, based on the mass of the hyperbranched polymer having a dithiocarbamate group at a molecular terminal thereof in which acid anhydrides are introduced. The reaction conditions are appropriately selected from reaction times of 0.01 to 200 hours and reaction temperatures of 0 to 200° C., preferably from reaction times of 0.1 to 150 hours and reaction temperatures of 10 to 100° C.

The hyperbranched polymer represented by Formula (4) of the present invention obtained by the above described hydrolyzing reaction can be separated from a solvent by distilling off the solvent out of the reaction solution or by a solid-liquid separation. In addition, by adding the reaction solution to a poor solvent, the hyperbranched polymer of the present invention can be also precipitated to be recovered as a powder.

Next, the production method of the hyperbranched polymer of the present invention having a structure represented by Formula (5):

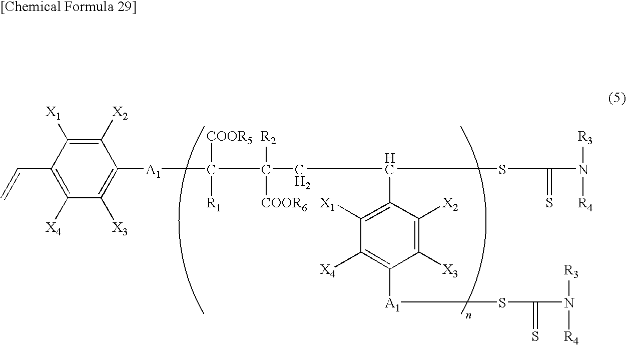

(where R₁, R₂, R₃, R₄, R₅, R₆, A₁, X₁, X₂, X₃ and X₄ represent the same as defined in Formula (1), Formula (2), Formula (3) and Formula (4); and n is the number of repeating unit structures which represents an integer of 2 to 100,000), is described.

The hyperbranched polymer represented by Formula (5) can be obtained by obtaining hyperbranched polymer having a dithiocarbamate group at a molecular terminal thereof in which acid anhydrides are introduced by living-radical polymerizing the dithiocarbamate compound represented by Formula (2) and the maleic anhydride compound represented by Formula (3) which are coexisting and further by hydrolyzing the obtained hyperbranched polymer, in other words, by converting the acid anhydrides into carboxyl groups.

As the production method of the hyperbranched polymer having a dithiocarbamate group at a molecular terminal thereof in which acid anhydrides are introduced, the production method as described in the section of the production method of the hyperbranched polymer represented by Formula (1) can be used.

Next, as the method of hydrolyzing this hyperbranched polymer, in other words, the method of converting the acid anhydrides into carboxyl groups, the hydrolyzing method described in the production method of the hyperbranched polymer having a structure represented by Formula (4) can be used.

The hyperbranched polymer represented by Formula (5) of the present invention obtained by the above described hydrolyzing reaction can be separated from a solvent by distilling-off the solvent out of the reaction solution or by a solid-liquid separation. In addition, by adding the reaction solution to a poor solvent, the hyperbranched polymer of the present invention can be precipitated to be recovered as a powder.

Further, by reducing to a hydrogen atom, a dithiocarbamate group of the hyperbranched polymer having a structure represented by Formula (5), the hyperbranched polymer represented by Formula (4) can also be produced. As the reducing method, the reducing method described in the production method of the hyperbranched polymer represented by Formula (1) can be used.

### EXAMPLES

Hereinafter, the present invention is described in more detail referring to examples which should not be construed as limiting the scope of the present invention.

In the following examples, for measurement of physical properties of a sample, the following apparatuses were used.

### (1) Liquid Chromatography

Apparatus: manufactured by Agilent; 1100 Series

Column: Inertsil ODS-2

Column temp.: 40° C.

Solvent: Acetonitrile/water=60/40 (volume ratio)

Detector: RI

### (2) Gel Permeation Chromatography

Apparatus: manufactured by Tosoh Corporation; HLC-8220GPC

Column: Shodex KF-805L+KF-804L

Column temp.: 40° C.

Solvent: Tetrahydrofuran

Detector: RI

### (3) FT-IR

Apparatus: manufactured by Nicolet Japan Corporation; NEXUS670

### (4) Thermogravimetric Analysis

Apparatus: manufactured by Rigaku Corporation; TG8120

Heating rate: 10° C./min

Air supply: 60 mL/min

### (5) Melting Point Analysis

Apparatus: manufactured by Rigaku Corporation; DSC8230

Heating rate: 2° C./min

Nitrogen supply: 60 mL/min

(6) Elemental Analysis (carbon, hydrogen, nitrogen)

Apparatus: manufactured by PerkinElmer Co., Ltd.; PE240011

Combustion tube temp.: 975° C.

(7) Elemental Analysis (sulfur)

Pre-treating apparatus: manufactured by Dia Instruments Co., Ltd.; Automatic quick furnace AQF-100

Combustion tube temp.: 1000° C.

Analyzing apparatus: manufactured by Japan Dionex Co., Ltd.; ICS-1500

Column: Dionex AS12A

Eluant: Na₂CO₃ 2.7 mM-NaHCO₃ 0.3 mM

(8) Elemental Analysis (sodium)

Apparatus: manufactured by SII NanoTechnology Inc.; Vista-Pro

### Reference Example 1

### Synthesis of N,N-diethyldithiocarbamylmethylstyrene

In a 2-L reaction flask, 120 g of chloromethylstyrene (manufactured by Seimi Chemical Co., Ltd.; trade name: CMS-14), 181 g of Sodium N,N-diethyldithiocarbamidate trihydrate (manufactured by Kanto Chemical Co., Inc.) and 1400 g of acetone were charged and while stirring the resultant mixture, the mixture was reacted at a temperature of 40° C. for 1 hour. After the completion of the reaction, deposited sodium chloride was filtered to be removed, and then acetone was distilled off from the reaction solution using an evaporator to thereby obtain a reaction crude powder. The obtained reaction crude powder was redissolved in toluene and the resultant liquid was separated in toluene/water. Thereafter, in a refrigerator having a temperature of −20° C., an aimed product was recrystallized from the toluene phase. The recrystallized substance was filtered and vacuum-dried to thereby obtain 206 g (yield; 97%) of an aimed product in the form of a white powder. The purity (area percentage) was 100% as measured by a liquid chromatography. The melting point was 56° C.

### Reference Example 2

Synthesis of Styrene-Maleic Anhydride-based Hyperbranched Polymer Having Dithiocarbamate Group at Molecular terminal Thereof

In a 1-L glass-made reaction flask, 25 g of N,N-diethyldithiocarbamylmethylstyrene, 9.24 g of maleic anhydride (manufactured by Kanto Chemical Co., Inc.) and 342 g of ethyl acetate were charged and the resultant mixture was stirred to prepare a pale yellow transparent solution, followed by replacing the inside of the reaction system with nitrogen. From the center of the solution, a high pressure mercury lamp of 100 W (manufactured by Sen Lights Co., Ltd.; HL-100) was lighted to effect a photopolymerization reaction by an internal irradiation while stirring the reaction solution at a temperature of 30±5° C. for 3 hours. Next, the reaction solution was added to 2 L of hexane to reprecipitate a polymer in a massive state having high viscosity and then a supernatant liquid was removed by a decantation. Further, the polymer was redissolved in 100 mL of ethyl acetate and then the resultant solution was added to 2 L of hexane to reprecipitate the polymer in a slurry state. The slurry was filtered and vacuum-dried to thereby obtain 15.7 g of an aimed product in the form of a pale yellow powder. The weight average molecular weight Mw and the degree of dispersion Mw/Mn of the polymer were measured by a gel permeation chromatography, in a converted molecular weight as polystyrene, and found to be 6,400 and 2.93, respectively. The results of the elemental analysis were carbon: 60.2% by mass, hydrogen: 5.2% by mass, nitrogen: 3.4% by mass and sulfur: 15.5% by mass. By a thermogravimetric analysis, it was found that the temperature at which the weight of the polymer was reduced by 5% was 210° C. The measured result of FT-IR is shown in FIG. 1. At 1781 cm⁻¹, a peak ascribed to the acid anhydride was observed.

### Example 1

### Reduction of Dithiocarbamate Group

In a 300 mL glass-made reaction flask, 8 g of the hyperbranched polymer having a dithiocarbamate group at a molecular terminal thereof obtained in Reference Example 2, 11.5 g of tributyltin hydride (manufactured by Sigma-Aldrich Corp.) and 72 g of tetrahydrofuran were charged and the resultant mixture was stirred to prepare a pale yellow transparent solution, followed by replacing the inside of the reaction system with nitrogen. From the center of the solution, a high pressure mercury lamp of 100 W (manufactured by Sen Lights Co., Ltd.; HL-100) was lighted to effect a photoreaction by an internal irradiation while stirring the reaction solution at a temperature of 30±5° C. for 5 hours. Next, the reaction solution was added to 1.5 L of hexane to thereby reprecipitate a hyperbranched polymer in a slurry state. The slurry was filtered and vacuum-dried to thereby obtain 5.0 g of a white powder-shaped hyperbranched polymer in which a dithiocarbamate group was replaced by a hydrogen atom. The weight average molecular weight Mw and the degree of dispersion Mw/Mn of the polymer were measured by a gel permeation chromatography, in a converted molecular weight as polystyrene, and found to be 17,900 and 5.16, respectively. The results of the elemental analysis were carbon: 65.6% by mass, hydrogen: 5.9% by mass, nitrogen: 0.5% by mass or less and sulfur: 0.5% by mass or less. By a thermogravimetric analysis, it was found that the temperature at which the weight of the polymer was reduced by 5% was 250° C. The measured result of FT-IR is shown in FIG. 2. At 1781 cm⁻¹, a peak ascribed to the acid anhydride was observed. From the measured result, the obtained hyperbranched polymer has a structure represented by Formula (22):

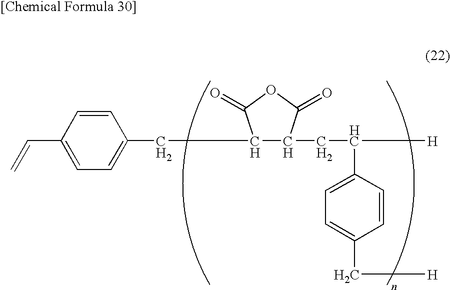

### Example 2

Hydrolysis of Styrene-Maleic Anhydride-based Hyperbranched Polymer in which Dithiocarbamate Group at Molecular terminal is reduced

In a 50 mL glass-made reaction flask, 0.2 g of the hyperbranched polymer in which a dithiocarbamate group at a molecular terminal thereof obtained in Example 1 is reduced to a hydrogen atom was dissolved in 8 g of tetrahydrofuran to prepare a pale yellow transparent solution. This solution was dropped into 4 g of an IN sodium hydroxide aqueous solution and the resultant slurry solution was stirred at a temperature of 20±5° C. for 24 hours. Next, to this reaction solution, 20 mL of methanol was added to precipitate a polymer in a powder state and then the polymer was filtered, washed with 200 mL of methanol and vacuum-dried to thereby obtain 0.15 g of an aimed product in the form of a pale yellowish-white powder. The results of the elemental analysis were carbon: 50.0% by mass, hydrogen: 5.4% by mass, nitrogen: 0.5% by mass or less, sulfur: 0.5% by mass or less and sodium: 11.7% by mass. By a thermogravimetric analysis, it was found that the temperature at which the weight of the polymer was reduced by 5% was 285° C. The obtained hyperbranched polymer was soluble in pure water with a solubility of 10% by mass or more. The measured result of FT-IR is shown in FIG. 3. A peak ascribed to the acid anhydride at 1781 cm⁻¹ disappeared and a peak ascribed to the carboxyl group sodium salt was observed at 1560 cm⁻¹. From the measured result, the obtained hyperbranched polymer has a structure represented by Formula (24):

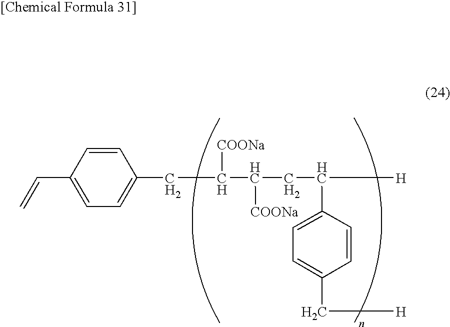

### Example 3

Hydrolysis of Styrene-Maleic Anhydride-based Hyperbranched Polymer having Dithiocarbamate Group at Molecular terminal Thereof

In a 50 mL glass-made reaction flask, 1 g of the hyperbranched polymer having a dithiocarbamate group at a molecular terminal thereof which is obtained in Reference Example 2 was dissolved in 15 g of tetrahydrofuran to prepare a pale yellow transparent solution. This solution was dropped into 8 g of an IN sodium hydroxide aqueous solution and the resultant slurry solution was stirred at a temperature of 20±5° C. for 18 hours. Next, to this reaction liquid, 20 mL of methanol was added to precipitate a polymer in a powder state and then the polymer was filtered, washed with 200 mL of methanol and then vacuum-dried to thereby obtain 1 g of an aimed product in the form of a pale yellowish-white powder. The results of the elemental analysis were carbon: 44.5% by mass, hydrogen: 5.0% by mass, nitrogen: 2.3% by mass, sulfur: 8.8% by mass and sodium: 8.7% by mass. By a thermogravimetric analysis, it was found that the temperature at which the weight of the polymer was reduced by 5% was 222° C. The obtained hyperbranched polymer was soluble in pure water with a solubility of 10% by mass or more. The measured result of FT-IR is shown in FIG. 4. A peak ascribed to the acid anhydride at 1781 cm^{31 1} disappeared and a peak ascribed to the carboxyl group sodium salt was observed at 1560 cm⁻¹. From the measured result, the obtained hyperbranched polymer has a structure represented by Formula (25):

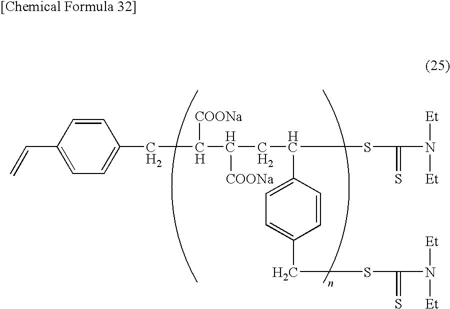

### Example 4

Hydrolysis of Styrene-Maleic Anhydride-based Hyperbranched Polymer having Dithiocarbamate Group at Molecular terminal Thereof

In a 50 mL glass-made reaction flask, 15 g of the hyperbranched polymer having a dithiocarbamate group at a molecular terminal thereof which is obtained in Reference Example 2, 300 g of 1,4-dioxane and 30 g of a 6N hydrochloric acid aqueous solution were charged and the resultant mixture was stirred to prepare a pale yellow transparent solution. Thereafter, this solution was stirred at a temperature of 80° C. for 10 hours and further, at a temperature of 20±5° C. for 5 days. Next, out of this solution, the solvent was distilled-off under reduced pressure and the resultant solid was dissolved in 50 g of acetone. The resultant solution was added to 900 g of a 0.5 N hydrochloric acid aqueous solution to precipitate a polymer in a powder state and then the polymer was filtered, washed with 200 mL of methanol and then vacuum-dried to thereby obtain 15.1 g of an aimed product in the form of a pale yellowish-white powder. The weight average molecular weight Mw and the degree of dispersion Mw/Mn of the polymer were measured by a gel permeation chromatography, in a converted molecular weight as polystyrene, and found to be 16,000 and 5.44, respectively. The results of the elemental analysis were carbon: 55.6% by mass, hydrogen: 5.6% by mass, nitrogen: 3.1% by mass, sulfur: 14.3% by mass. By a thermogravimetric analysis, it was found that the temperature at which the weight of the polymer was reduced by 5% was 181° C. The obtained hyperbranched polymer was soluble in a 2.4% by mass tetramethylammonium hydroxide aqueous solution with a solubility of 5% by mass or more. The measured result of FT-IR is shown in FIG. 5. A peak ascribed to the acid anhydride at 1781 cm⁻¹ disappeared and a peak ascribed to the carboxyl group was observed at 1718 cm⁻¹. From the measured result, the obtained hyperbranched polymer has a structure represented by Formula (26):

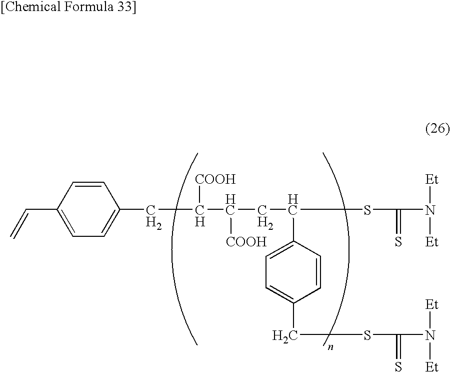

As is apparent from the comparison between the results of the thermogravimetric analysis in Reference Example 2 and Example 1, the hyperbranched polymer in which a dithiocarbamate group at a molecular terminal thereof is converted into a hydrogen atom has a high temperature at which the weight of the polymer was reduced by 5%, so that the polymer is thermally-stable. This can be mentioned from the comparison between the results of the thermogravimetric analysis of the hydrolyzed products in Examples 2 and 3.

In addition, while Reference Example 2 and Example 1 were insoluble in an aqueous solution, the hydrolyzed products of Examples 2, 3, and 4 were soluble in an aqueous solution. Further, as is apparent from the comparisons between Examples 1 and 2 and between Reference Example 2 and Example 3, the hyperbranched polymers hydrolyzed with metal hydroxides have high temperatures at which the weight of the polymer was reduced by 5% in the thermogravimetric analysis.

### INDUSTRIAL APPLICABILITY

Since the hyperbranched polymer of the present invention is optically and thermally stable and further, to which characteristic of water-solubility is imparted, the hyperbranched polymer can be utilized as painting materials, adhesive materials, resin filler, various forming materials, nanometer pore forming agent, resist materials, electronic materials, printing materials, battery materials, medical materials, and the like.

### BRIEF DESCRIPTION OF THE DRAWINGS

FIG. 1 is an FT-IR spectrum of a hyperbranched polymer obtained in Reference Example 2.

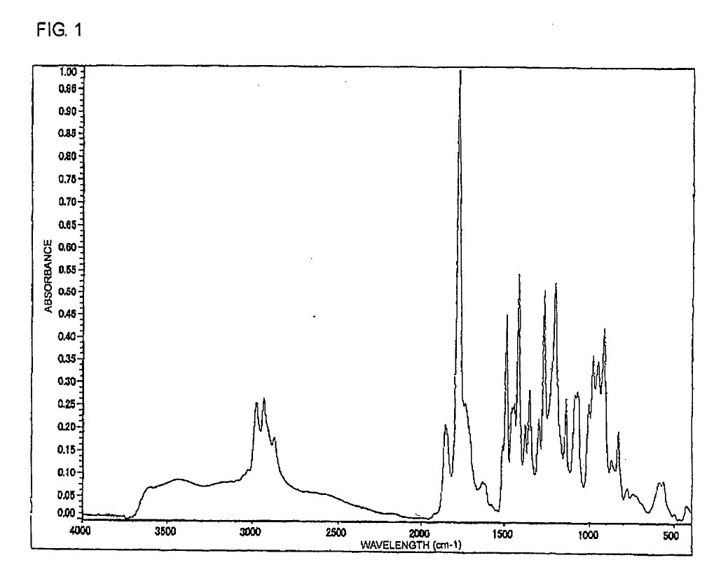

FIG. 2 is an FT-IR spectrum of a hyperbranched polymer obtained in Example 1.

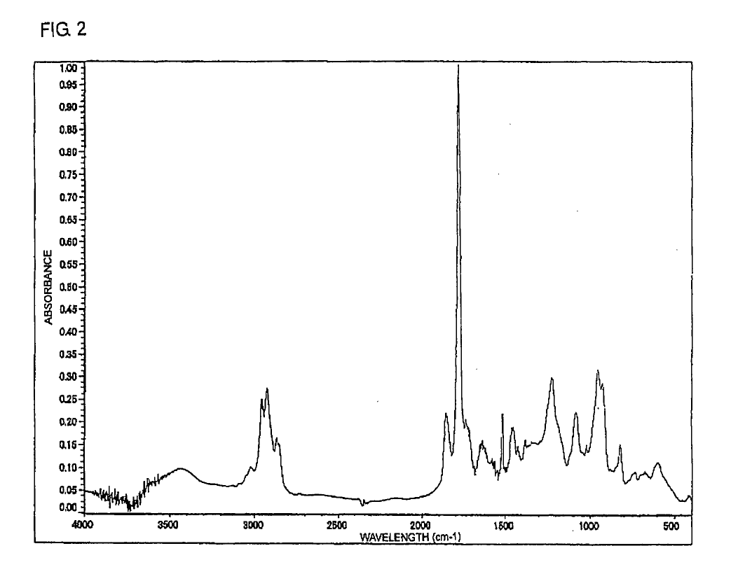

FIG. 3 is an FT-IR spectrum of a hyperbranched polymer obtained in Example 2.

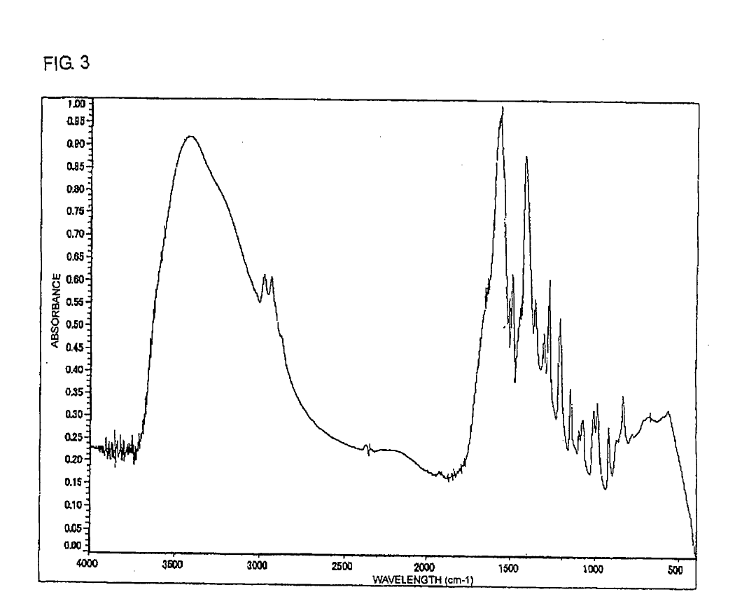

FIG. 4 is an FT-IR spectrum of a hyperbranched polymer obtained in Example 3.

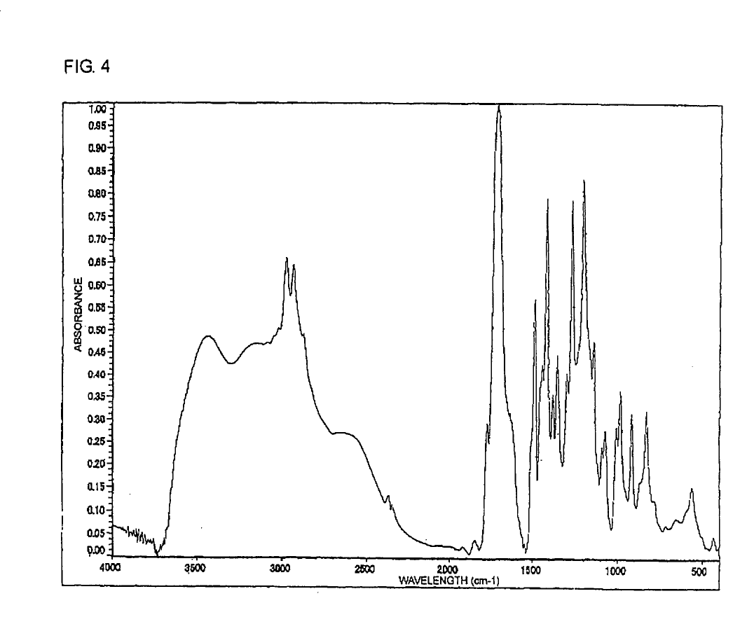

FIG. 5 is an FT-IR spectrum of a hyperbranched polymer obtained in Example 4.

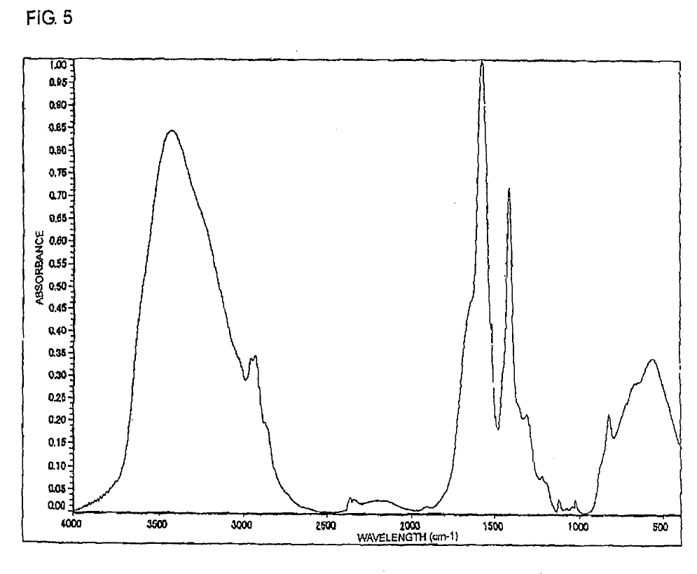

1. A hyperbranched polymer having a structure represented by Formula (1): 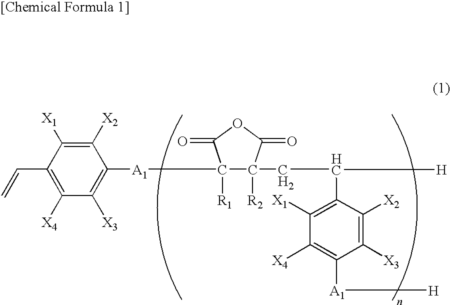
(where each of R₁ and R₂ independently represents a hydrogen atom, an alkyl group having 1 to 10 carbon atoms or a phenyl group, or R₁ and R₂ are bonded to each other to form a cycloalkyl group or cycloalkenyl group having 4 to 10 carbon atoms together with a carbon atom bonded to R₁ and R₂; A₁ represents a linear, branched or cyclic alkylene group having I to 20 carbon atoms, which may contain an ether bond or an ester bond; X₁, X₂, X₃ and X₄ individually represent a hydrogen atom, an alkyl group having 1 to 20 carbon atoms or an alkoxy group having 1 to 20 carbon atoms; and n is the number of repeating unit structures which represents an integer of 2 to 100,000).

2. The hyperbranched polymer according to claim 1, wherein a weight average molecular weight is 500 to 5,000,000, as measured by a gel permeation chromatography in a converted molecular weight as polystyrene.

3. A production method of the hyperbranched polymer as claimed in claim 1, the production method comprising:
living-radical polymerizing a dithiocarbamate compound represented by Formula (2): 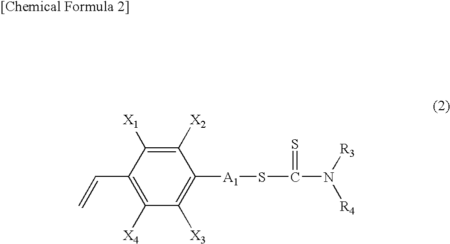
(where A₁, X₁, X₂, X₃ and X₄ represent the same as defined in Formula (1); R₃ and R₄ individually represent an alkyl group having 1 to 5 carbon atoms, a hydroxyalkyl group having 1 to 5 carbon atoms or an arylalkyl group having 7 to 12 carbon atoms, or R₃ and R₄ can be bonded to each other to form a ring together with a nitrogen atom bonded to R₃ and R₄,
and maleic anhydride compound represented by Formula (3): 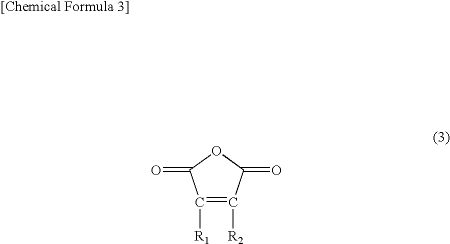
(where R₁ and R₂ represent the same as defined in Formula (1)), which are coexisting; and
reducing a dithiocarbamate group at a molecular terminal of the hyperbranched polymer obtained by the polymerization to a hydrogen atom.

4. The production method according to claim 3, wherein the dithiocarbamate compound is N,N-diethyldithiocarbamylmethylstyrene.

5. The production method according to claim 3, wherein the maleic anhydride compound is maleic anhydride.

6. The production method according to claim 3, wherein the dithiocarbamate compound is N,N-diethyldithiocarbamylmethylstyrene and the maleic anhydride compound is maleic anhydride.

7. The production method according to claim 3, wherein the reduction is performed by irradiating a light in the presence of tributyltin hydride.

8. The production method according to claim 3, wherein the reduction is performed by irradiating a light in the presence of tributyltin hydride in an organic solvent solution containing the hyperbranched polymer having a dithiocarbamate group at a molecular terminal thereof.

9. A hyperbranched polymer having a structure represented by Formula (4): 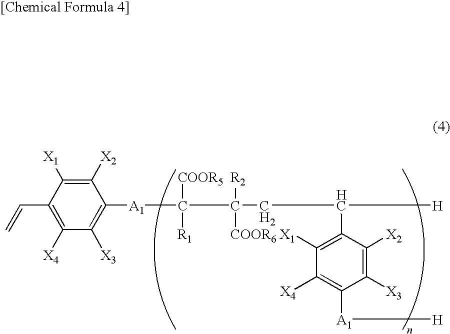
where each of R₁ and R₂ independently represents a hydrogen atom, an alkyl group having 1 to 10 carbon atoms or a phenyl group, or R₁ and R₂ are bonded to each other to form a cycloalkyl group or cycloalkenyl group having 4 to 10 carbon atoms together with a carbon atom bonded to R₁ and R₂; A₁ represents a linear, branched or cyclic alkylene group having 1 to 20 carbon atoms, which may contain an ether bond or an ester bond, X₁,X₂, X₃ and X₄ individually represent a hydrogen atom, an alkyl group having 1 to 20 carbon atoms or an alkoxy group having 1 to 20 carbon atoms; R₅ and R₆ individually represent a hydrogen atom or a metal atom; and n is the number of repeating unit structures which represents an integer of 2 to 100,000).

10. A production method of the hyperbranched polymer as claimed in claim 9, the production method further comprising hydrolyzing a hyperbranched polymer having a structure represented by Formula (1): 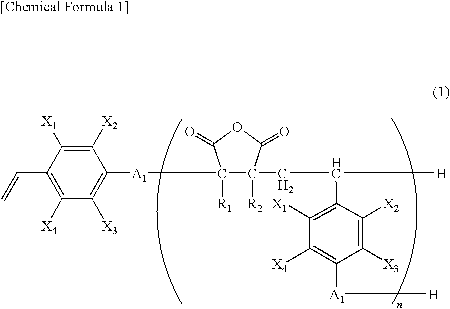
(where each of R₁ and R₂ independently represents a hydrogen atom, an alkyl group having 1 to 10 carbon atoms or a phenyl group, or R₁ and R₂ are bonded to each other to form a cycloalkyl group or cycloalkenyl group having 4 to 10 carbon atoms together with a carbon atom bonded to R₁ and R₂; A₁ represents a linear, branched or cyclic alkylene group having 1 to 20 carbon atoms, which may contain an ether bond or an ester bond; X₁, X₂, X₃ and X₄ individually represent a hydrogen atom, an alkyl group having 1 to 20 carbon atoms or an alkoxy group having 1 to 20 carbon atoms, and n is the number of repeating unit structures which represents an integer of 2 to 100.000).

11. The production method according to claim 10, wherein the hydrolysis is performed according to an alkali hydrolysis reaction using a water-soluble base which is an alkali metal hydroxide or an alkaline earth metal hydroxide, or according to an acid hydrolysis reaction using a water-soluble acid which is a halogenated hydrogen acid, nitric acid or sulfuric acid.

12. The production method according to claim 10, wherein the hydrolysis is performed in a solvent mixture of water and an organic solvent, according to an alkali hydrolysis reaction using a water-soluble base which is an alkali metal hydroxide or an alkaline earth metal hydroxide, or according to an acid hydrolysis reaction using a water-soluble acid which is a halogenated hydrogen acid, nitric acid or sulfuric acid.

13. A hyperbranched polymer having a structure represented by Formula (5): 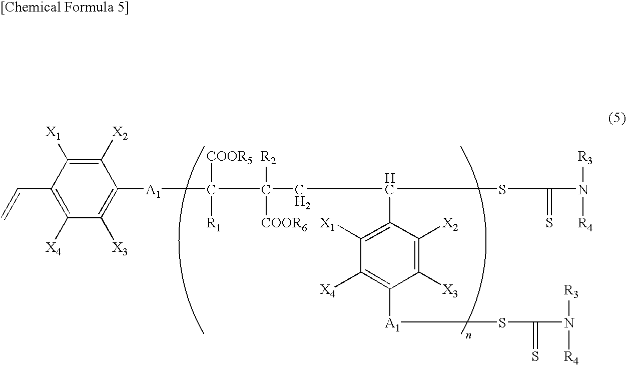
(where each of R₁ and R₂ independently represents a hydrogen atom, an alkyl group having 1 to 10 carbon atoms or a phenyl group, or R₁ and R₂ are bonded to each other to form a cycloalkyl group or cycloalkenyl group having 4 to 10 carbon atoms together with a carbon atom bonded to R₁ and R₂; A₁ represents a linear, branched or cyclic alkylene group having 1 to 20 carbon atoms, which may contain an ether bond or an ester bond; X₁, X₂, X₃ and X₄ individually represent a hydrogen atom, an alkyl group having 1 to 20 carbon atoms or an alkoxy group having 1 to 20 carbon atoms; R₃ and R₄ individually represent an alkyl group having 1 to 5 carbon atoms, a hydroxyalkyl group having 1 to 5 carbon atoms or an arylalkyl group having 7 to 12 carbon atoms, or R₃ and R₄ can be bonded to each other to form a ring together with a nitrogen atom bonded to R₃ and R₄; R₅ and R₆ individually represent a hydrogen atom or a metal atom; and n is the number of repeating unit structures which represents an integer of 2 to 100,000).

14. A production method of the hyperbranched polymer as claimed in claim 13, the production method comprising:
hydrolyzing the hyperbranched polymer having a dithiocarbamate group at a molecular terminal thereof obtained by living-radical polymerizing the dithiocarbamate compound represented by Formula (2): 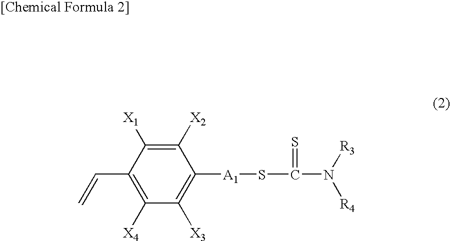
(where A₁, X₁, X₂, X₃ and X₄ represent the same as defined in Formula (1); R₃ and R₄ individually represent an alkyl group having 1 to 5 carbon atoms, a hydroxyalkyl group having 1 to 5 carbon atoms or an arylalkyl group having 7 to 12 carbon atoms, or R₃ and R₄ can be bonded to each other to form a ring together with a nitrogen atom bonded to R₃ and R₄),
and the maleic anhydride compound represented by Formula (3): 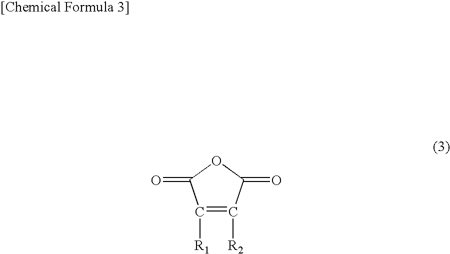
(where each of R₁ and R₂ independently represents a hydrogen atom, an alkyl group having 1 to 10 carbon atoms or a phenyl group, or R₁ and R₂ are bonded to each other to form a cycloalkyl group or cycloalkenyl group having 4 to 10 carbon atoms together with a carbon atom bonded to R₁ and R₂); which are coexisting.

15. The production method according to claim 14, wherein the dithiocarbamate compound is N,N-diethyldithiocarbamylmethylstyrene and the maleic anhydride compound is maleic anhydride.

16. The production method according to claim 14, wherein the hydrolysis is performed according to an alkali hydrolysis reaction using a water-soluble base which is an alkali metal hydroxide or an alkaline earth metal hydroxide, or according to an acid hydrolysis reaction using a water-soluble acid which is a halogenated hydrogen acid, nitric acid or sulfuric acid.

17. The production method according to claim 14, wherein the hydrolysis is performed in a solvent mixture of water and an organic solvent, according to an alkali hydrolysis reaction using a water-soluble base which is an alkali metal hydroxide or an alkaline earth metal hydroxide, or according to an acid hydrolysis reaction using a water-soluble acid which is a halogenated hydrogen acid, nitric acid or sulfuric acid.

18. A production method of the hyperbranched polymer as claimed in claim 9, the production method comprising:
reducing a hyperbranched polymer as having a structure represented by Formula (5): 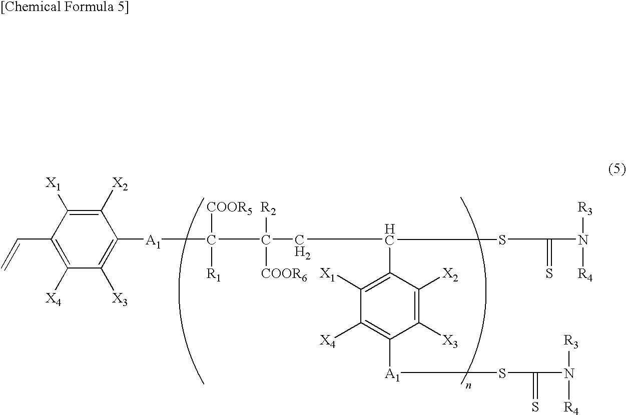
(where each of R₁ and R₂ independently represents a hydrogen atom, an alkyl group having 1 to 10 carbon atoms or a phenyl group, or R₁ and R₂ are bonded to each other to form a cycloalkyl group or cycloalkenyl group having 4 to 10 carbon atoms together with a carbon atom bonded to R₁ and R_{2; A}₁ represents a linear branched or cyclic alkylene group having 1 to 20 carbon atoms, which may contain an ether bond or an ester bond; X₁, X₂, X₃ and X₄ individually represent a hydrogen atom, an alkyl group having 1 to 20 carbon atoms or an alkoxy group having 1 to 20 carbon atoms, R₃ and R₄ individually represent an alkyl group having 1 to 5 carbon atoms, a hydroxyalkyl group having 1 to 5 carbon atoms or an arylalkyl group having 7 to 12 carbon atoms, or R₃ and R₄ can be bonded to each other to form a ring together with a nitrogen atom bonded to R₃ and R_{4; R}₅ and R₆ individually represent a hydrogen atom or a metal atom; and n is the number of repeating unit structures which represents an integer of 2 to 100,000),
by reducing the dithiocarbamate group at a molecular terminal of the hyperbranched polymer to a hydrogen atom by irradiating a light in the presence of tributylin hydride.

19. A production method of a hyperbranched polymer as claimed in claim 9, the production method comprising:
reducing a hyperbranched polymer as having a structure represented by Formula (5): 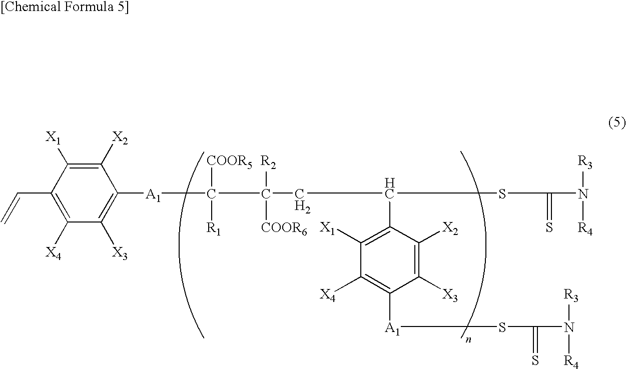
(where each of R₁ and R₂ independently represents a hydrogen atom, an alkyl group having 1 to 10 carbon atoms or a phenyl group, or R₁ and R₂ are bonded to each other to form a cycloalkyl group or cycloalkenyl group having 4 to 10 carbon atoms together with a carbon atom bonded to R₁ and R₂; A₁ represents a linear, branched or cyclic alkylene group having 1 to 20 carbon atoms, which may contain an ether bond or an ester bond; X₁, X₂, X₃ and X₄ individually represent a hydrogen atom, an alkyl group having 1 to 20 carbon atoms or an alkoxy group having 1 to 20 carbon atoms; R₃ and R₄ individually represent an alkyl group having 1 to 5 carbon atoms, a hydroxyalkyl group having 1 to 5 carbon atoms or an arylalkyl group having 7 to 12 carbon atoms, or R₃ and R₄ can be bonded to each other to form a ring together with a nitrogen atom bonded to R₃ and R₄; R₅ and R₆ individually represent a hydrogen atom or a metal atom; and n is the number of repeating unit structures which represents an integer of 2 to 100,000),
by reducing the dithiocarbamate group at a molecular terminal of the hyperbranched polymer to a hydrogen atom by irradiating a light in the presence of tributylin hydride in an organic solvent solution containing the hyperbranched polymer having a dithiocarbonate group at a molecular terminal thereof.
